(19) United States
(12) Patent Application Publication
(10) Pub. No.: US 2025/0149662 A1
(43) Pub. Date: May 8, 2025

(54) BATTERY INSPECTION AND METHOD THEREOF

(71) Applicant: SK On Co., Ltd., Seoul (KR)

(72) Inventors: Jung Soo CHANG, Daejeon (KR); Oh Jae KWON, Daejeon (KR); Tae Gyun KIM, Daejeon (KR); Ung Bae PARK, Daejeon (KR); Yu Ri SONG, Daejeon (KR); Dong Whan SHIN, Daejeon (KR); Jae Hee AHN, Daejeon (KR); Byoung Hak LEE, Daejeon (KR); Jung Taek LIM, Daejeon (KR); Young Jin JANG, Daejeon (KR)

(21) Appl. No.: 18/932,527

(22) Filed: Oct. 30, 2024

(30) Foreign Application Priority Data
Nov. 2, 2023 (KR) 10-2023-0150193
Sep. 4, 2024 (KR) 10-2024-0119912

(51) Int. Cl. H01M 10/42; G01N 27/20; G01N 27/62

(52) U.S. Cl. CPC H01M 10/4285; G01N 27/205; G01N 27/62; H01M 10/4207

(57) ABSTRACT

The present disclosure provides a battery inspection device and a battery inspection method. The battery inspection device includes: a plasma application unit irradiating plasma to a test object while being moved in a predetermined direction; a signal acquisition unit contacting the test object and electrically connected thereto, and receiving an electrical signal induced by plasma; and a control unit controlling the plasma application unit and the signal acquisition unit, wherein the control unit determines whether damage has occurred to the exterior of the test object by analyzing a waveform derived from the electrical signal received from the signal acquisition unit.

### CROSS-REFERENCE TO RELATED APPLICATION(S)

This patent document claims the priority and benefits of Korean Patent Application Nos. 10-2023-0150193 filed on Nov. 2, 2023 and 10-2024-0119912 filed on Sep. 4, 2024, the disclosures of which are incorporated herein by reference in its entirety.

### TECHNICAL FIELD

The present disclosure relates to a battery inspection device and a battery inspection method.

### BACKGROUND

A secondary battery, unlike a primary battery, has convenience that can be charged and discharged, and is attracting a lot of attention as a power source for various mobile devices and electric vehicles. Unlike a primary battery, a secondary battery may be charged and discharged, so the secondary battery may be applied to devices within various fields such as digital cameras, mobile phones, laptops, hybrid cars, electric cars, and energy storage systems (ESS).

Such a secondary battery may include a battery cell in which an electrode assembly formed by stacking a positive electrode plate, a negative electrode plate, and a separator or by winding the same in a roll shape is accommodated inside a case. A plurality of battery cells may be stacked in a predetermined direction and accommodated in a battery module or battery pack. Battery cells may include a pouch-type battery cell, a cylindrical-type battery cell, and a prismatic-type battery cell depending on the shape or type of the case.

Meanwhile, when damage occurs to an exterior of the case of the battery cell, it can cause serious safety risks as well as performance degradation. Therefore, research is needed for a means of quickly and accurately inspecting the exterior of the case of the battery cell for damage.

### SUMMARY

According to an aspect of the present disclosure, whether damage to a case of a battery cell has occurred may be inspected more quickly and accurately through an electrical method than through a visual inspection.

According to an aspect of the present disclosure, whether damage has occurred, such as a metal layer of the case being exposed to the exterior in a pouch cell, may be accurately inspected.

A battery cell, an inspection object of the present disclosure, may be widely applied to devices within green technology fields such as electric vehicles, battery charging stations, and solar and wind power generation using batteries. In addition, the battery cells may be used in eco-friendly electric vehicles, hybrid vehicles, or the like, to prevent climate change by suppressing air pollution and greenhouse gas emissions.

According to an aspect of the present disclosure, a battery inspection device may include: a plasma application unit irradiating plasma to a test object while being moved in a predetermined direction; a signal acquisition unit contacting the test object and electrically connected thereto, and receiving an electrical signal induced by plasma; and a control unit controlling the plasma application unit and the signal acquisition unit, wherein the control unit may determine whether damage has occurred to the exterior of the test object by analyzing a waveform derived from the electrical signal received from the signal acquisition unit.

According to an aspect of the present disclosure, the battery inspection device may further include: a current supply unit supplying current to the plasma application unit; and a gas supply unit supplying gas to the plasma application unit, wherein the control unit may control the current supply unit and the gas supply unit to induce plasma to be generated in the plasma application unit.

According to an embodiment, the test object may include: at least one battery cell including a case having an accommodating portion having an accommodating space and accommodating an electrode assembly; and a sealing portion formed on at least one edge of the accommodating portion, wherein the case may include: an inner layer disposed in the accommodating space and facing the electrode assembly; an outer layer disposed to be exposed to the exterior; and an intermediate layer disposed between the inner layer and the outer layer and including an electrically conductive material.

According to an embodiment, the inner layer, the intermediate layer, and the outer layer are exposed to the exterior through at least one edge of the case, and the signal acquisition unit is provided to contact the intermediate layer at the edge of the case, and is electrically connectable to the intermediate layer.

According to an embodiment, the case includes a cutting unit formed by cutting at least one corner through a virtual cutting line at at least one corner, the inner layer, the intermediate layer, and the outer layer are exposed to the exterior through the cutting unit, and the signal acquisition unit is provided to contact the intermediate layer in the cutting unit and is electrically connectable to the intermediate layer.

According to an embodiment, the plasma application unit may include a plasma body connected to the control unit; and a plasma nozzle connected to the plasma body and generating plasma.

According to an embodiment, the plasma nozzle may be formed to be elongated in a direction perpendicular to the predetermined direction.

According to an embodiment, a plurality of the plasma nozzles are provided, and the plurality of plasma nozzles may be arranged in a first row and a second row, and may be arranged in a pattern in which the plurality of plasma nozzles of the second row are disposed between the plurality of plasma nozzles of the first row.

According to an embodiment, a plurality of the plasma application units may be provided, to face a plurality of surfaces of the case, and the plurality of plasma application units may irradiate plasma to the plurality of surfaces of the case while being moved in the predetermined direction.

According to an embodiment, the test object may include a battery module including a housing and a plurality of battery cells arranged in the predetermined direction in the housing, and a plurality of the signal acquisition units may be provided and may contact each of the plurality of battery cells and be electrically connected thereto.

According to an embodiment, the plasma application unit may be provided to apply plasma to the plurality of battery cells while being moved in the predetermined direction.

According to an embodiment of the present disclosure, a battery inspection method may include: a test object disposition operation of disposing a test object; a signal acquisition unit contact operation of contacting a signal acquisition unit with at least one edge of the test object, to be electrically connected to the test object; a plasma application unit moving operation of applying plasma to the test object while moving the plasma application unit in a predetermined direction relative to the test object; and a waveform analysis operation of analyzing a waveform of an electrical signal induced by plasma and received through the signal acquisition unit and determining whether damage has occurred to the test object.

According to an embodiment of the present disclosure, the test object may include at least one battery cell including a case having an accommodating portion having an accommodating space and accommodating an electrode assembly, and a sealing portion formed on at least one edge of the accommodating portion, and the case may include an inner layer disposed in the accommodating space and facing the electrode assembly; an outer layer disposed to be exposed to the exterior; and an intermediate layer disposed between the inner layer and the outer layer and including an electrically conductive material, wherein the test object disposition operation may further include forming a cutting unit by cutting at least one corner of the case along a virtual cutting line.

According to an embodiment of the present disclosure, in the signal acquisition unit contact operation, the signal acquisition unit may contact the intermediate layer of the case exposed through the cutting unit.

According to an embodiment of the present disclosure, in the waveform analysis operation, the electrical signal received from the signal acquisition unit is analyzed and if it is determined that a damage wave, a waveform in which the electrical signal bounces more than a standing wave, a waveform of an electrical signal in a normal state, has occurred, information can be displayed externally.

The solution according to the present disclosure has been described, but this is exemplary, and it should be understood that other configurations that are not mentioned are also included in the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a structural diagram of a battery inspection device of the present disclosure;

FIG. 2 is an example diagram of a battery inspection device of the present disclosure;

FIG. 3 is a diagram of a plasma application unit according to an embodiment;

FIG. 4 is a diagram of a battery cell according to an embodiment;

FIG. 5 is a diagram of a signal acquisition unit and

a battery cell according to an embodiment;

FIG. 6 is a diagram illustrating a normal state;

FIG. 7 a diagram illustrating a defective state;

FIG. 8 is an example diagram of a current waveform in a normal state and a defective state;

FIG. 9A is a diagram of a plasma application unit according to an embodiment;

FIG. 9B is a diagram of a plasma application unit according to another embodiment;

FIG. 10A is a diagram of a plurality of surfaces being inspected simultaneously;

FIG. 10B a diagram illustrating FIG. 10A from a different direction;

FIG. 11 is an example diagram of a plurality of battery cells being inspected;

FIG. 12 a diagram of a defective battery cell being inspected in a plurality of battery cells; and

FIG. 13 is a flowchart of a battery inspection method of the present disclosure.

### DETAILED DESCRIPTION

Prior to the detailed description of the present disclosure, the terms or words used in the present specification and claims described below should not be construed as being limited to a common or dictionary meaning, and the inventor intends to use his/her invention in the best way. Based on the principle that terms may be properly defined for description, they should be interpreted as meanings and concepts consistent with the technical spirit of the present disclosure.

The same reference numbers or symbols described in each drawing represent parts or components that perform substantially the same functions. For convenience of description and understanding, the same reference numbers or symbols may be used in different embodiments.

In the following description, singular expressions include plural expressions unless the context clearly dictates otherwise. It should be understood that terms such as “include” or “comprise” are intended to specify the presence of a feature, number, step, operation, component, part, or combination thereof described in the specification, but do not exclude in advance the possibility of the presence or addition of one or more other features, numbers, steps, operations, components, parts, or combinations thereof.

In addition, in the following description, expressions such as upper side, upper portion, lower side, lower portion, side surface, front, rear, etc. are expressed based on the direction illustrated in the drawings, and may be expressed differently if the direction of the object is changed.

In addition, terms including ordinal numbers such as “first,” “second,” or the like. may be used to distinguish between components in the description and claims below. These ordinal numbers are used to distinguish between identical or similar components, and the meaning of the terms should not be limited due to the use of these ordinal numbers. For example, the components associated with these ordinal numbers should not be interpreted in a restricted order of use or disposition by their numbers. If necessary, respective ordinal numbers may be used interchangeably.

Hereinafter, the present disclosure will be described in detail with reference to the drawings.

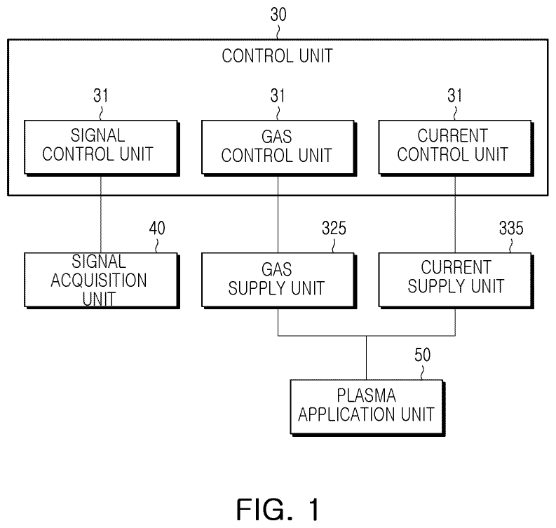

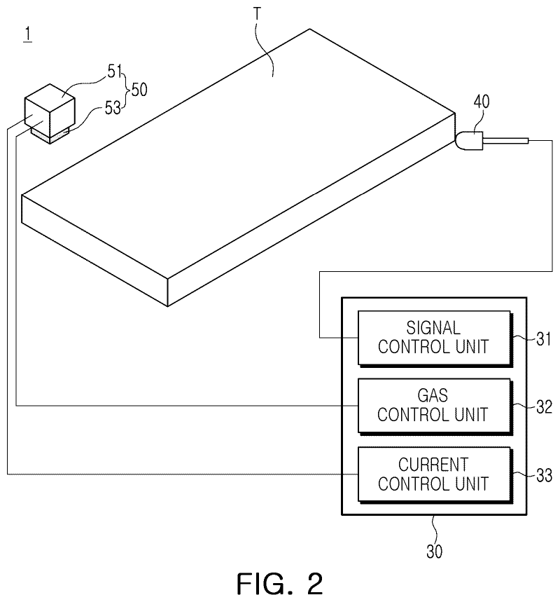

FIG. 1 is a structural diagram of a battery inspection device of the present disclosure, and FIG. 2 is an example diagram of a battery inspection device of the present disclosure.

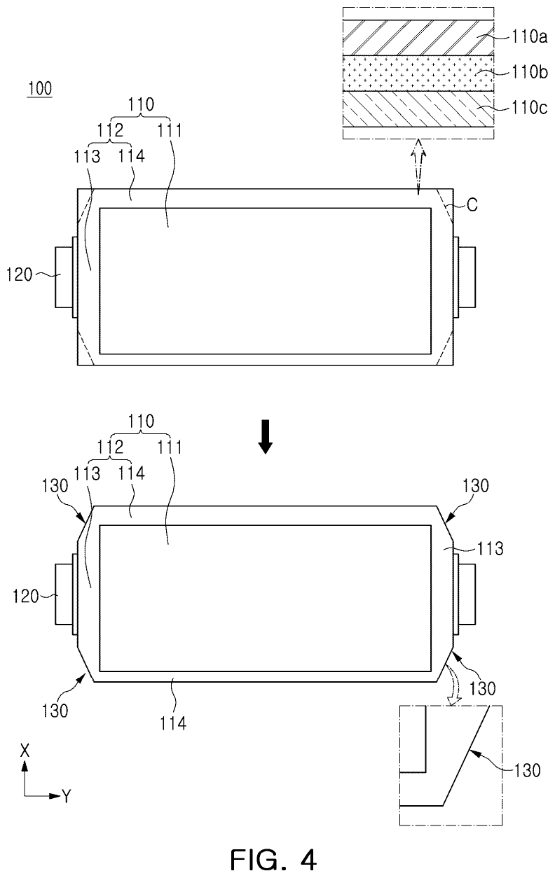

Referring to FIGS. 1 and 2, a battery inspection device 1 of the present disclosure may include a plasma application unit 50 applying plasma to a test object (T), a signal acquisition unit 40 acquiring an electrical signal from the test object, and a control unit 30 controlling the plasma application unit 50 and the signal acquisition unit 40. Here, the test object (T) may mean a battery cell 100 (see FIG. 4), an inspection object of the battery inspection device 1 of the present disclosure.

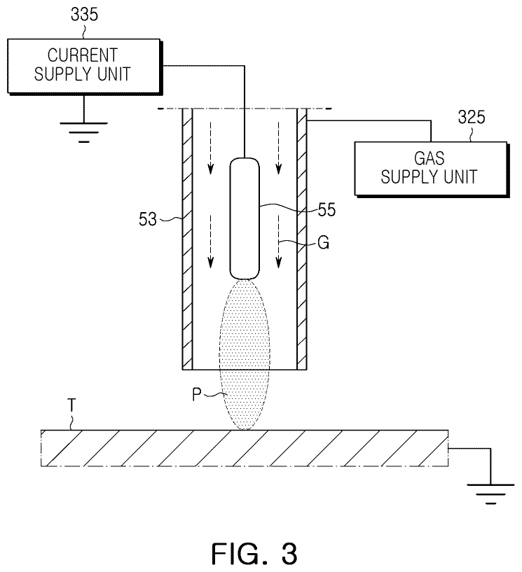

Specifically, the battery inspection device 1 of the present disclosure may include a plasma application unit 50 irradiating plasma P (see FIG. 3) to a test object (T) while being moved in a predetermined direction, a signal acquisition unit 40 contacting the test object (T) and electrically connected thereto, and receiving an electrical signal induced by plasma P, and a control unit 30 controlling the plasma application unit 50 and the signal acquisition unit 40, and the control unit 30 may analyze a waveform derived from the electrical signal received from the signal acquisition unit 40 to determine whether damage (f) (see FIG. 7) has occurred to the exterior of the test object (T).

As described above, the battery inspection device 1 of the present disclosure may inspect whether damage has occurred to the exterior of the test object (T) by applying plasma to the test object (T) through the plasma application unit 50, acquiring an electrical signal induced thereby from the signal acquisition unit 40 and analyzing the same with the control unit 30.

In addition, in the present disclosure, the battery inspection device may further include a gas supply unit 325 supplying gas to the plasma application unit 50 and a current supply unit 335 supplying current. The control unit 30 may control the gas supply unit 325 and the current supply unit 335 to induce plasma to be generated in the plasma application unit 50. The plasma application unit 50 may apply plasma to a test object (T) by applying current to the supplied gas. The plasma application unit 50 may include a plasma body 51 that can be connected to the control unit 30 and a plasma nozzle 53 generating plasma.

The signal acquisition unit 40 may measure current of the test object (T) in real time, by being in contact with a conductive portion of the test object (T). The signal acquisition unit 40 may receive a change in an electrical signal of the test object (T) caused by plasma.

The control unit 30 may include a signal control unit 31 receiving and controlling an electrical signal received from a signal acquisition unit 40, a gas control unit 32 controlling a gas supply unit 325 supplying gas to the plasma application unit 50, and a current control unit 33 controlling the current supply unit 335 supplying current to the plasma application unit 50. In addition, the control unit 30 may control the plasma application unit 50 so that the plasma application unit 50 may move relative to the test object (T).

According to an embodiment, the control unit 30 may control plasma to be generated by the plasma application unit 50 and move a position of the plasma application unit 50. The control unit 30 may include a processor analyzing an electrical signal received from the signal acquisition unit 40 into a waveform. The control unit 30 may analyze the electrical signal to determine whether damage has occurred to the exterior of the test object (T).

Hereinafter, the principle of generating plasma through a plasma application unit 50 is explained with reference to the drawings.

FIG. 3 is a diagram of a plasma application unit according to an embodiment.

Referring to FIG. 3, the plasma application unit 50 may further include a plasma discharge unit 55 connected to the power supply unit 335. The gas supply unit 325 may supply gas G to the interior of the plasma nozzle 53, and the current supply unit 335 may supply current to the plasma discharge unit 55.

Here, gas G may include gas ionized at a voltage applied from a plasma discharge unit 55. According to an embodiment, the gas G may include an inert gas such as argon (Ar), helium (He) to stably generate plasma (P) and ensure the reliability of inspection. The control unit 30 may control the gas supply unit 325 to supply gas (G) to a plasma nozzle 53. In addition, the control unit 30 may control the current supply unit 335 to apply a strong voltage (e.g., 10-30 kV) to the plasma discharge unit 55.

The plasma application unit 50 may supply sufficient energy to electrons of gas molecules by applying a strong voltage to the gas (G) flowing from the plasma nozzle 53 through the plasma discharge unit 55. The electrons supplied with energy may be accelerated and separated from atomic nucleus. In this process, the gas (G) may be ionized to generate plasma (P), and positively charged cations and negatively charged free electrons may be formed. As described above, the ionized gas (G), i.e. plasma (P), may become highly activated with the electrons separated.

Meanwhile, free electrons separated from the atomic nucleus may move at high speeds and continuously and repeatedly collide with other surrounding molecules. Such collision energy may induce chain ionization, thereby increasing the density of the plasma (P) and expanding the plasma (P). By this principle, the plasma (P) may be applied to a surface of a test object (T) to induce a conductor of the test object (T) to conduct electricity.

Hereinafter, a structure for inspecting the exterior of a battery cell 100 using a test object (T) as a battery cell 100 is described.

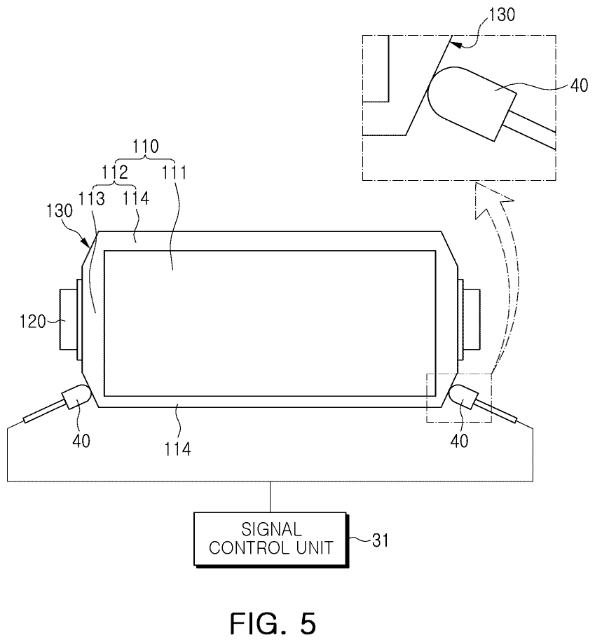

FIG. 4 is a diagram of a battery cell according to an embodiment, and FIG. 5 is a diagram of a signal acquisition unit and a battery cell according to an embodiment.

According to an embodiment of the present disclosure, the test object (T) may be a battery cell 100. That is, the battery test device 1 of the present disclosure may inspect the exterior of a case of the battery cell 100.

Before explaining a structure for inspecting a battery cell 100 through a battery inspection device 1, a battery cell 100, a test object (T), is first explained. The battery cell 100 of the present disclosure may

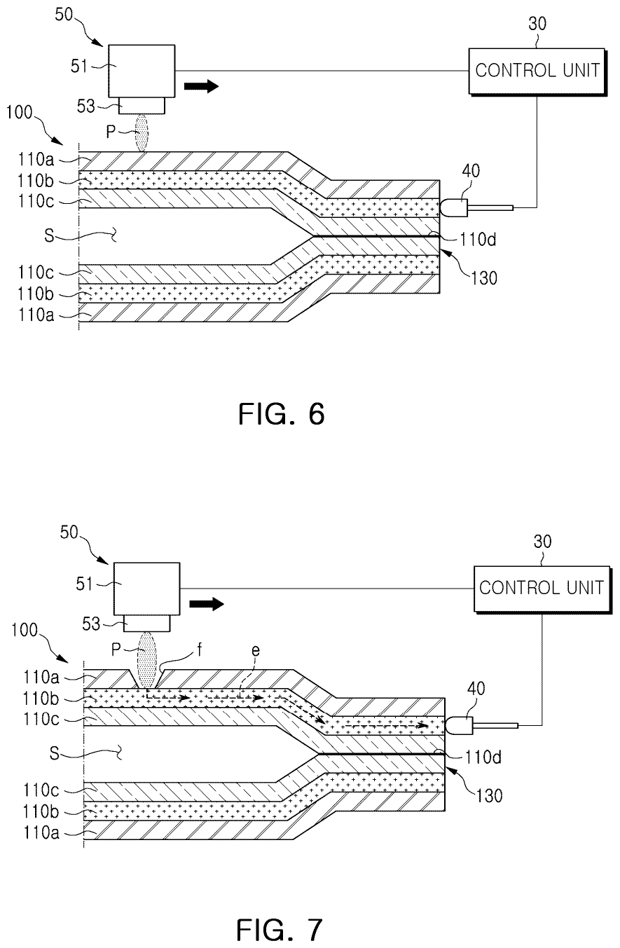

include a case 110 accommodating an electrode assembly (not shown) in an accommodating space S (see FIG. 6). In addition, the battery cell 100 may include a lead tab 120 electrically connected to the electrode assembly and protruding toward at least one side of the case 110.

The electrode assembly may be configured in a stacked form with a separator interposed between a positive electrode plate and a negative electrode plate so that wide surfaces thereof face each other. The positive electrode plate may be formed by applying a positive electrode active material to a positive electrode current collector, and the negative electrode plate may be formed by applying a negative electrode active material to a negative electrode current collector. The separator may be configured to prevent electrical short-circuits between the positive electrode and negative electrode plates and to allow ion flow. For example, the separator may include a porous polymer film or a porous nonwoven fabric.

In addition, be the electrode assembly may accommodated in the case in a jelly-roll type, formed by being wound in a predetermined direction, and may be accommodated in the case in various manners, such as a stacking type, a zigzag (Z)-folding type, a stack-folding type, or the like.

The battery cell 100 may be a pouch-type, prismatic-type, or cylindrical-type secondary battery depending on the structure of the case 110.

Hereinafter, the battery cell 100 of the present disclosure is described as a pouch cell formed of a pouch-type outer shell, but the present disclosure is not limited thereto, and any device that can inspect damage (f) (see FIG. 7) to the exterior of the case 110 through plasma P is considered to belong to the present disclosure.

According to an embodiment, the case 110 may include a receiving portion 111 for accommodating an electrode assembly in an accommodating space S and a sealing portion 112 disposed on at least one edge of the accommodating portion 111 to seal the accommodating space S. In other words, the accommodating portion 111 is a portion of the case 110 that is provided with the accommodating space S to receive the electrode assembly, and may refer to a portion of the case 110 that is not sealed. That is, the accommodating portion 111 may refer to a portion of the case 110 other than the sealing portion 112.

The sealing portion 112 is a portion sealing the accommodating space of the case 110, and may refer to a portion formed on at least one edge of the case 110. The sealing portion 112 may include a first sealing portion 113 formed on an edge in which a lead tab 120 is disposed and a second sealing portion 114 formed on an edge in which the lead tab 120 is not disposed.

According to the present disclosure, the case 110 may be fused with the outer materials facing each other so that all four edges thereof are not folded. That is, according to an embodiment, a sealing portion 112 may be formed on the four edges. However, the present disclosure is not limited to the number of sealing portions 112. According to the present disclosure, the sealing portion 112 may be disposed on three of the four edges of the battery cell 100. The case 110 may be formed by folding a single sheet of outer material to surround the electrode assembly, and the outer materials may be sealed while facing each other at three edges thereof that are not folded. That is, the case 110 may have the sealing portion 112 formed on three of the four edges. Meanwhile, referring to an upper drawing of FIG. 4,

the case 110 of the present disclosure may include a plurality of layers. According to an embodiment, the case 110 may include an inner layer 110c in contact with the accommodating space S, an outer layer 110a exposed to the exterior, and an intermediate e layer 110b disposed therebetween and including an electrically conductive material. In an embodiment, each layer may be comprised of a plurality of layers.

The inner layer 110c of the present disclosure may be a layer facing an electrode assembly and may be a layer in contact with the accommodating space S. The inner layer 110c may be formed of a material having heat resistance, electrolyte resistance, insulation, or the like. The intermediate layer 110b may be formed of a material including an electrically conductive metal material (e.g., aluminum) to secure mechanical rigidity of the case 110. The outer layer 110c is a layer exposed to the exterior and may include an electrically insulating material to prevent short circuits. According to the present disclosure, it is possible to quickly detect and inspect damage (f) occurring in the outer layer 110a due to impact or the like, thereby exposing the metal material intermediate layer 110b (illustrated in FIGS. 6 and 7).

According to the present disclosure, a terrace portion of the battery cell 100 may be cut along a virtual cutting line (c). Here, the terrace portion refers to a space of the case 110 between the accommodating portion 111 and a corner of the case 110, and may refer to a region including the sealing portion 112 in the drawing. According to an embodiment, for reasons related to a subsequent manufacturing process of the battery cell 100, the terrace portion may be cut along a virtual cutting line (c) to form a cutting unit 130.

For example, the cutting line (c) may be a virtual line for cutting a corner portion of the case 110 so that the battery cell 100 can be more easily inserted into a roller during the process of folding the sealing portion 112 during the manufacturing process of the battery cell 100. However, the present disclosure is not limited thereto.

That is, according to an embodiment of the present disclosure, the battery cell 100, a test object (T), may further include a cutting unit 130. The signal acquisition unit 40 may be in contact with the cutting unit 130. Specifically, the signal acquisition unit 40 may be in contact with the intermediate layer 110b exposed through the cutting unit 130.

However, the present disclosure is not limited thereto. For example, in the present disclosure, a cutting unit 130 may not be formed and a signal acquisition unit 40 contact an edge portion of the case 110, thereby may contacting the intermediate layer 110b exposed through the edge.

Specifically, the inner layer 110c, the intermediate layer 110b, and the outer layer 110c may be exposed to the exterior through at least one edge of the case 110. Here, the signal acquisition unit 40 may contact the intermediate layer 110b exposed through the edge and be electrically connected thereto.

Meanwhile, at edges other than the cutting unit 130, as the sealing portion 112 is fused, the intermediate layer 110b may be at least partially covered. Accordingly, in the present disclosure, by forming a cutting unit 130 in the battery cell 100, and contacting the signal acquisition unit 40 to the cutting unit 130, the reliability of signal acquisition may be increased.

According to the present disclosure, the battery cell 100 may include at least one cutting unit 130. The cutting unit 130 may be formed by cutting at least one corner portion of the battery cell 100. That is, the cutting unit 130 of the present disclosure may be formed in at least one corner portion of the battery cell 100.

The signal acquisition unit 40 may contact at least one cutting unit 130 of the battery cell 100. For example, as shown in the drawing, the signal acquisition unit 40 may be disposed in two cutting units 130 from four cutting units 130, and may be in contact with the intermediate layer 110b.

The signal control unit 31 may be connected to at least one signal acquisition unit 40, and may receive electrical characteristics of the battery cell 100 (test object; T), such as electrical signals, current waveforms, or the like, received from the signal acquisition unit 40.

Hereinafter, a structure for inspecting damage to the exterior of the case 110 through plasma P is described with reference to the drawings.

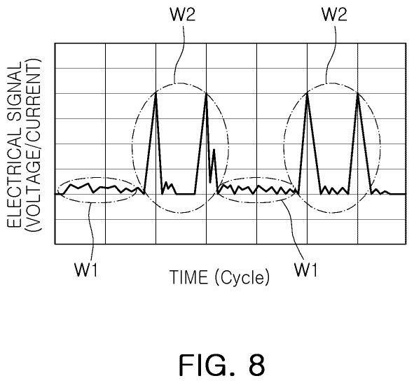

FIG. 6 illustrates a normal state, FIG. 7 illustrates a defective state, and FIG. 8 illustrates current waveforms in a normal state and a defective state. FIG. 6 illustrates a battery cell 100 in a normal state, and FIG. 7 illustrates a battery cell 100 in a defective state in which damage (f) has occurred in the case 110.

The signal acquisition unit 40 may contact an intermediate layer 110b of the case 110. Specifically, the signal acquisition unit 40 may be electrically connected to the intermediate layer 110b exposed through the cutting unit 130.

The plasma application unit 50 may apply plasma P to the outer layer 110a of the case 110 from the exterior of the case 110. The plasma application unit 50 may apply plasma P to the case 110 while being moved in a predetermined direction along the case 110 exposed to the exterior.

Referring to FIG. 6, a case 110 in a normal state in which an outer layer 110a including an electrically insulating material insulates an intermediate layer 110b from the exterior is illustrated. In this case, even if the plasma application unit 50 applies plasma P to the case 110, the signal acquisition unit 40 connected to the intermediate layer 110b may not acquire an electrical signal induced by the plasma P.

Referring to FIG. 7, it is illustrated that damage (f) has occurred to the outer layer 110c due to impact, or the like. That is, at least a portion of the intermediate layer 110b may be exposed externally through the damage (f). In this case, when the plasma application unit 50 applies plasma P to the case 110, in the intermediate layer 110b, a flow of current (e) may be induced by plasma P through damage (f), and the current (e) may be received by the signal acquisition unit 40.

When the control unit 30 receives an electrical signal, or the like from the signal acquisition unit 40, the control unit 30 may analyze the electrical signal into a waveform, and thereby, may determine whether the case 110 is in a normal state or a defective state in which damage (f) has occurred.

Referring to FIG. 8, according to an embodiment, the electrical signal received by the control unit 30 is derived as a waveform is illustrated. The graph of FIG. 8 illustrates a standing wave W1, a waveform of an electrical signal indicating a normal state, as shown in FIG. 6, and a damage wave W2, a waveform of an electrical signal indicating a defective state, as shown in FIG. 7.

As shown in the drawing, when damage (f) has occurred in the case 110, an electrical signal induced by the plasma P is received by the control unit 30 through the signal acquisition unit 40, and the electrical signal bounces more than usual. This is referred to as a damage wave W2. A standing wave W1 illustrates a state in which an electric signal remains relatively constant over time as compared to a damage wave W2, and may be an electric waveform received by a signal acquisition unit 40 in a normal state, as shown in FIG. 6.

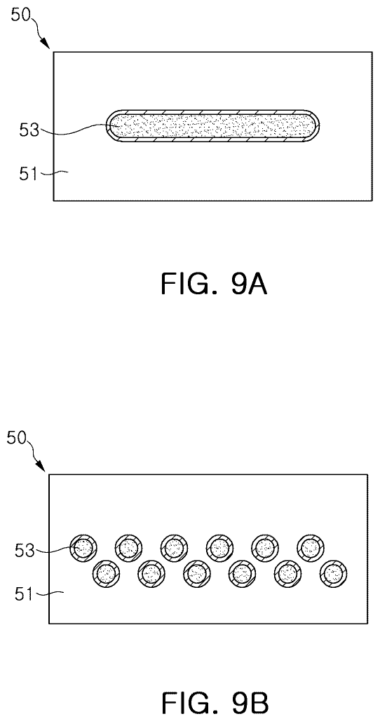

FIGS. 9A and 9B illustrate a dispositional structure of a nozzle of a plasma application unit 50 of the present disclosure.

Referring to FIG. 9A, in an embodiment, the plasma application unit 50 may have a plasma nozzle 53 formed in an elongated shape in a plasma body 51. Thereby, an applied region of the plasma P may be increased.

Specifically, the plasma nozzle 53 may be formed to be elongated in a direction perpendicular to the moving direction.

Referring to FIG. 9B, the plasma application unit 50 of another embodiment may have a plurality of plasma nozzles 53 disposed therein. The plurality of plasma nozzles 53 may be formed in a plurality of rows as shown in the drawing, and a plasma nozzle 53 of the next row may be disposed alternately between the plurality of plasma nozzles 53 of one row, so that the plasma nozzles 53 may be disposed in a zig-zag pattern. That is, a plurality of the plasma nozzles may be provided, and the plurality of plasma nozzles may be arranged in a first row and a second row, and the plasma nozzle 53 may be arranged in a pattern in which the plurality of plasma nozzles of the second row are disposed between the plurality of plasma nozzles of the first row.

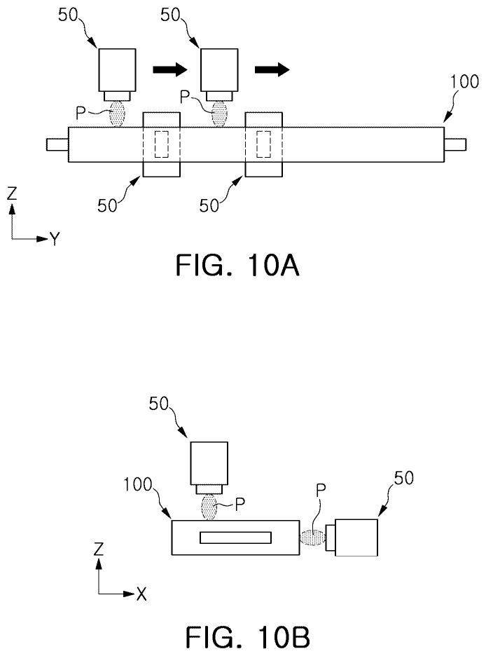

FIG. 10A illustrates a plurality of surfaces being inspected simultaneously. FIG. 10B illustrates FIG. 10A from a different direction.

According to the present disclosure, a battery inspection device 1 may inspect a plurality of surfaces of the battery cell 100 simultaneously. Referring to FIGS. 10A and 10B, the battery inspection device 1 may include a plurality of plasma application units 50. The plurality of plasma application units 50 may be disposed on different surfaces.

For example, as shown in the drawing, a plasma application unit 50 may be respectively disposed on an upper surface (+Z-axis direction) and a side surface (X-axis direction) of the battery cell 100. The plurality of plasma application units 50 may inspect the upper surface and the side surface of the battery cell 100 simultaneously while being moved in a longitudinal direction (Y-axis direction). However, the present disclosure is not limited thereto. For example, the plasma application unit 50 may be disposed to face a plurality of surfaces of the battery cell 100 and apply plasma P, so that the battery inspection device 1 may inspect the plurality of surfaces of the battery cell 100 at once.

In other words, referring to FIG. 10A and FIG. 10B, a plurality of plasma application units 50 may be provided to face a plurality of surfaces of the case 110 and the plurality of plasma application units 50 may irradiate plasma P onto a plurality of surfaces of the case 110 while being moved in a predetermined direction. Thereby, the plurality of surfaces of the case 110 may be inspected at once.

In addition, the plurality of plasma application units 50 may be disposed on one surface to inspect different regions, or inspect the same region a plurality of times, thereby improving the reliability of the inspection.

Meanwhile, in the present disclosure, not only a plurality of surfaces of the battery cell 100 may be inspected simultaneously, but also the plurality of battery cells 100 may be inspected simultaneously. Hereinafter, a structure for inspecting the plurality of battery cells 100 at one time will be described.

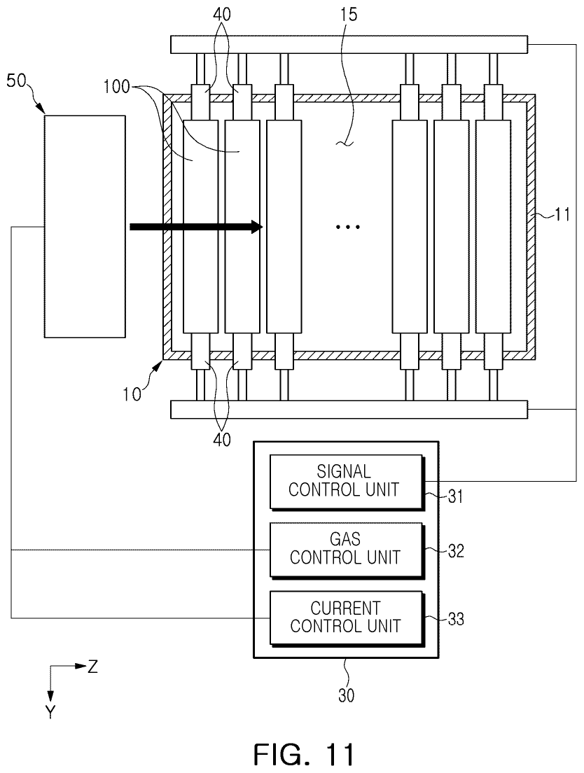

FIG. 11 illustrates a plurality of battery cells being inspected.

According to the present disclosure, the test object (T) may be a battery module 10 including a plurality of battery cells 100. The battery module 10 may include a housing 11 in which a plurality of battery cells 100 are accommodated in an internal space 15. The plurality of battery cells 100 may be stacked in a predetermined direction (Z-axis direction in the drawing) in the internal space 15 of the housing 11.

According to an embodiment, in a state in which an upper portion of the battery module is exposed, a plurality of signal acquisition units 40 may be respectively connected to a plurality of battery cells 100 through the exposed upper portion thereof. According to an embodiment, the plurality of signal acquisition units 40 may contact the intermediate layer 110b of the cutting unit 130 of the battery cell 100 through the exposed upper portion of the housing 11.

Specifically, the test object (T) may be a battery module 10 including a housing 11 having an internal space 15 and a plurality of battery cells 100 arranged in the predetermined direction in the housing 11. Here, a plurality of the signal acquisition units 40 may be provided and may contact each of the plurality of battery cells 100 and electrically connected thereto.

The structure in which the control unit 30, the plasma application unit 50, and the signal acquisition unit 40 are connected and in contact with the battery cell 100 has been described above, so redundant detailed contents thereof are omitted.

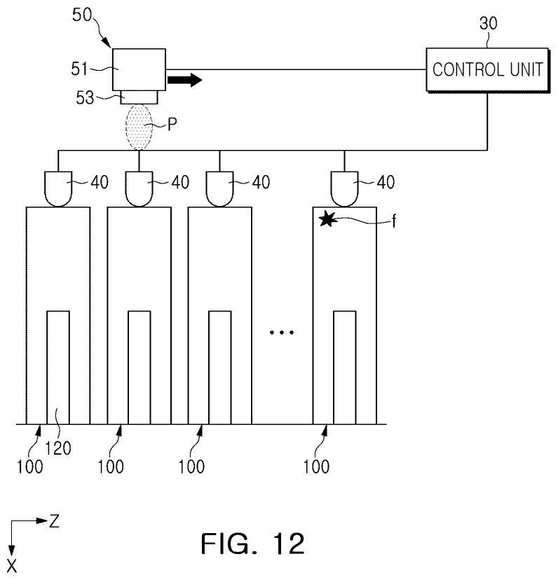

FIG. 12 illustrates a defective battery cell being inspected in a plurality of battery cells.

According to an embodiment of the present disclosure, the plasma application unit 50 may be provided to apply plasma P to a plurality of battery cells 100 while being moved in a stacking direction (Y-Z axis direction in the drawing) of the plurality of battery cells 100. In this case, a defective battery cell 100 in which damage (f) has occurred among the plurality of battery cells 100 may cause a current flow by plasma P, and the signal acquisition unit 40 may receive such an electrical signal and transmit the signal to the control unit 30. A waveform analysis method of the battery cell 100 in which damage (f) has occurred is omitted as the method is described above in FIG. 8.

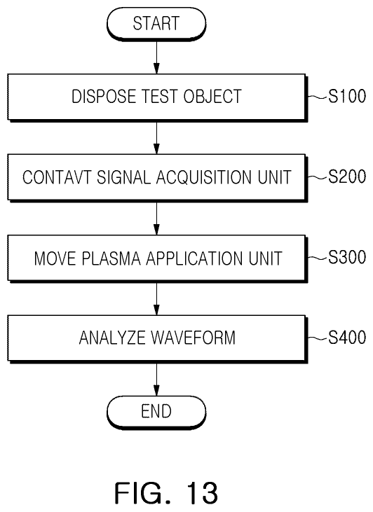

FIG. 13 is a flowchart of a battery inspection method of the present disclosure.

The battery inspection method according to an embodiment of the present disclosure may include disposing a test object (T) on a battery inspection device 1 (S100), contacting a signal acquisition unit 40 to at least one edge of a test object (T) to be electrically connected to the test object (T) (S200), applying plasma to the test object (T) through a plasma application unit 50 and moving the test object (T) relative to the test object (T) (S300), and analyzing a waveform of an electrical signal induced by plasma and received through the signal acquisition unit 40 and determining whether damage (f) to the test object has occurred (S400).

In the operation (S100) of disposing a test object (T), the test object (T) may mean at least one of a battery cell 100 or a battery module 10 receiving a plurality of the battery cells 100. In addition, the disposing the test object (T) may include forming a cutting unit 130 by cutting at least one corner of the case 110 along a virtual cutting line (c).

In the operation (S200) of contacting a signal acquisition unit 40, the signal acquisition unit 40 may contact an edge portion of the battery cell 100. In this case, the signal acquisition unit 40 may contact the intermediate layer 110b exposed through the cutting unit 130 and may be electrically connected thereto.

The operation (S300) of moving the plasma application unit may include generating plasma P in the plasma application unit 50 through the gas supply unit 325 and the current supply unit 335.

According to an embodiment, the plasma application unit 50 may be moved in a predetermined direction along the case 110 of the battery cell 100 while generating plasma P (see FIGS. 6 and 7).

According to another embodiment, the plasma application unit 50 may move along the stacking direction of the plurality of battery cells 100 to inspect whether damage (f) has occurred to the plurality of battery cells 100.

The waveform analysis operation (S400) may be an operation in which an electrical signal received from the signal acquisition unit 40 is analyzed by the control unit 30 as shown in FIG. 8. The control unit 30 may analyze the received electrical signal into a standing wave W1 and a damage wave W2, and when it is determined that a damage wave W2 has occurred, information may be displayed externally through an alarm, or the like. An operator may determine whether a damage (f) has occurred to through the displayed alarm and a battery cell 100 in which a damage (f) has occurred may be treated as defective, thereby increasing battery production reliability and yield.

That is, the waveform analysis operation (S400) may analyze the electrical signal received from the signal acquisition unit 40 and when it is determined that a damage wave W2, a waveform in which an electrical signal bounces more than a standing wave W1, a waveform of a waveform of an electrical signal in a normal state, has occurred, information may be displayed externally. Here, “electrical signal bounces” may refer to cases where the waveform of the damage wave (W2) is amplified compared to the waveform of the normal wave (W1), or where the voltage displacement of the damage wave (W2) is greater than that of the normal wave (W1).

As set forth above, according to an embodiment of the present disclosure, according to a battery inspection device and a battery inspection method, whether damage to a case of a battery cell has occurred may be more quickly and accurately inspected through an electrical method than through a visual inspection.

In a battery inspection device and battery inspection method according to an embodiment of the present disclosure, whether damage has occurred, such as a metal layer of a case being exposed to the exterior in a pouch cell, may be accurately inspected.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

The above-described description is merely an example of applying the principles of the present disclosure, and other configurations may be further included without departing from the scope of the present disclosure.

What is claimed is:

1. A battery inspection device, comprising:
a plasma application unit irradiating plasma to a test object while being moved in a predetermined direction;
a signal acquisition unit contacting the test object and electrically connected thereto, and receiving an electrical signal induced by plasma; and
a control unit controlling the plasma application unit and the signal acquisition unit,
wherein the control unit determines whether damage has occurred to an exterior of the test object by analyzing a waveform derived from the electrical signal received from the signal acquisition unit.

2. The battery inspection device of claim 1, further comprising:
a current supply unit supplying current to the plasma application unit; and
a gas supply unit supplying gas to the plasma application unit,
wherein the control unit controls the current supply unit and the gas supply unit to induce plasma to be generated in the plasma application unit.

3. The battery inspection device of claim 1, wherein the test object comprises at least one battery cell including a case having an accommodating portion having an accommodating space and accommodating an electrode assembly, and a sealing portion formed on at least one edge of the accommodating portion,
wherein the case includes
an inner layer disposed in the accommodating space and facing the electrode assembly;
an outer layer disposed to be exposed to the exterior; and
an intermediate layer disposed between the inner layer and the outer layer and including an electrically conductive material.

4. The battery inspection device of claim 3, wherein the intermediate layer is exposed to outside of the case through at least one edge of the case, and
the signal acquisition unit is provided to contact the intermediate layer at the at least one edge of the case, and is electrically connected to the intermediate layer.

5. The battery inspection device of claim 3, wherein the case comprises a cutting unit formed by cutting at least one corner through a virtual cutting line,
the intermediate layer is exposed to outside of the case through the cutting unit, and
the signal acquisition unit is provided to contact the intermediate layer in the cutting unit and is electrically connected to the intermediate layer.

6. The battery inspection device of claim 1, wherein the plasma application unit comprises
a plasma body connected to the control unit; and
a plasma nozzle connected to the plasma body and generating plasma.

7. The battery inspection device of claim 6, wherein the plasma nozzle is formed to be elongated in a direction perpendicular to the predetermined direction.

8. The battery inspection device of claim 6, wherein a plurality of the plasma nozzles are provided, and the plurality of plasma nozzles are arranged in a first row and a second row, and
the plurality of plasma nozzles of the second row are disposed between the plurality of plasma nozzles of the first row.

9. The battery inspection device of claim 3, wherein a plurality of the plasma application units are provided to face a plurality of surfaces of the case, and
the plurality of plasma application units irradiate plasma to the plurality of surfaces of the case while being moved in the predetermined direction.

10. The battery inspection device of claim 1, wherein the test object comprises a battery module including a housing and a plurality of battery cells arranged in the predetermined direction in the housing, and
a plurality of the signal acquisition units are provided and are in contact with each of the plurality of battery cells and electrically connected thereto.

11. The battery inspection device of claim 10, wherein the plasma application unit is provided to apply plasma to the plurality of battery cells while being moved in the predetermined direction.

12. A battery inspection method, comprising:
a test object disposition operation of disposing a test object;
a signal acquisition unit contact operation of contacting a signal acquisition unit with at least one edge of the test object, to be electrically connected to the test object;
a plasma application unit moving operation of applying plasma to the test object while moving the plasma application unit in a predetermined direction relative to the test object; and
a waveform analysis operation of analyzing a waveform of an electrical signal induced by plasma and received through the signal acquisition unit and determining whether damage has occurred to the test object.

13. The battery inspection method of claim 12, wherein the test object comprises at least one battery cell including a case having an accommodating portion having an accommodating space and accommodating an electrode assembly, and a sealing portion formed on at least one edge of the accommodating portion, and
the case includes
an inner layer disposed in the accommodating space and facing the electrode assembly;
an outer layer disposed to be exposed to the exterior; and
an intermediate layer disposed between the inner layer and the outer layer and including an electrically conductive material,
wherein the test object disposition operation further includes forming a cutting unit by cutting at least one corner of the case through a virtual cutting line.

14. The battery inspection method of claim 13, wherein, in the signal acquisition unit contact operation, the signal acquisition unit is in contact with the intermediate layer of the case exposed through the cutting unit.

15. The battery inspection method of claim 14, wherein, in the waveform analysis operation, the electrical signal received from the signal acquisition unit is analyzed and if it is determined that a damage wave, a waveform in which an electrical signal bounces more than a standing wave, a waveform of an electrical signal in a normal state, has occurred, information is displayed externally.
